(19) United States
(12) Patent Application Publication
(10) Pub. No.: US 2020/0159013 A1
(43) Pub. Date: May 21, 2020

(54) HEAD UP DISPLAY APPARATUS

(71) Applicants: MAXELL, LTD., Kyoto (JP); HITACHI INDUSTRY & CONTROL SOLUTIONS, LTD., Ibaraki (JP)

(72) Inventors: Koji HIRATA, Kyoto (JP); Masahiko YATSU, Kyoto (JP); Toshinori SUGIYAMA, Kyoto (JP); Kazuomi KANEKO, Ibaraki (JP)

(21) Appl. No.: 16/321,479

(22) PCT Filed: Jun. 23, 2017
(86) PCT No.: PCT/JP2017/023186

§ 371 Date: Jan. 29, 2019

(30) Foreign Application Priority Data
Aug. 8, 2016 (JP) 2016-155237

(51) Int. Cl. G02B 27/01; B60K 35/00

(52) U.S. Cl. CPC G02B 27/01; B60K 35/00; B60K 2370/332; B60K 2370/1529; G02B 2027/013

(57) ABSTRACT

A head up display apparatus configured to display a virtual image corresponding to video to a driver by projecting the video onto a windshield of a vehicle, includes: a video display apparatus including an LED light source and a display element, the video display apparatus being configured to form the video on the display element; and a virtual image optical system configured to cause light emitted from the video display apparatus to be reflected by the windshield to display the virtual image in front of the vehicle. The virtual image optical system includes a concave mirror and an optical element, and a freeform surface of the concave mirror is set so that an optical axis of video light traveling from the concave mirror toward the windshield is inclined in a horizontal direction.

### TECHNICAL FIELD

The present invention relates to a technique of a head up display apparatus, and more specifically, the present invention relates to a technique that is effective to be applied to a head up display apparatus, which projects an image onto a transparent glass plate or the like.

### BACKGROUND ART

For example, in a vehicle such as an automobile, information such as vehicle speed or the number of revolutions of an engine is normally displayed on an instrument panel board (or an instrument panel) in a dashboard. Further, a screen for car navigation or the like is displayed on a display that is built in the dashboard or mounted on the dashboard. In a case where a driver visually recognizes these kinds of information, there is need to largely move a visual line. Therefore, as a technique to reduce a moving amount of the visual line, a head up display (Head Up Display: hereinafter, referred to also as an “HUD”) apparatus is known that projects information such as vehicle speed or information such as an instruction related to car navigation onto a windshield and displays the information.

As a technique related to the HUD, for example, Japanese Patent Application Publication No. 2015-194707 (Patent document 1) describes a display apparatus including a display device to display an image and a projection optical system to project the image displayed on the display device, in which screen distortion is made smaller in the whole area of a field of view of an observer and miniaturization is realized. Here, the projection optical system includes a first mirror and a second mirror in order from the display device to an optical path of the observer. Patent document 1 describes that by configuring the projection optical system so that a relationship among an incident angle to the first mirror in an image long axis direction, an incident angle to the first mirror in an image short axis direction, an interval between an image display surface of the display device and the first mirror, and a width of a virtual image viewed and recognized by the observer in a horizontal direction satisfies a predetermined relation, miniaturization of the HUD apparatus is realized.

### RELATED ART DOCUMENTS

### Patent Documents

Patent document 1: Japanese Patent Application Publication No. 2015-194707

### SUMMARY OF THE INVENTION

### Problems to be Solved by the Invention

In a conventional technique as described in Patent document 1, it was possible to miniaturize a configuration of the apparatus. However, there are constraints on miniaturization. Namely, in the technique described in Patent document 1, there is need to arrange two mirrors between the observer and the display device. In this case, in order for a light flux reflected by the first mirror not to be cut off by the second mirror, a degree of freedom of arrangement of the mirrors is restricted. Namely, there are constraints to arrange the two mirrors closely, and there is necessity to arrange the two mirrors so as to be spaced to an extent. Therefore, this becomes an obstacle to miniaturization of the apparatus configuration.

Further, in a case where the HUD apparatus is mounted on a vehicle such as an automobile, the following problems are pointed out particularly. Namely, in a case where the vehicle is exposed under strong solar light such as midsummer, the solar light enters from an opening through which video light is projected onto the windshield depending upon an irradiation angle, and reversely travels on an optical path of the video light via a reflecting mirror to reach a liquid crystal panel that is a video display apparatus of the HUD apparatus. In a case of the worst, a polarizing plate at an emission side is damaged or deteriorated by the concentrated solar light. With respect to such intrusion of solar light, in a configuration in which a plurality of mirrors is installed in a relatively large housing like the conventional HUD apparatus described above, a measure to radiate part of heat due to the solar light to the outside can be applied. However, temperature rise of the HUD housing, which is generated by intrusion of solar light, occurs more remarkably particularly in a case where the HUD apparatus is miniaturized.

For this reason, when junction temperature of an LED that is a light source of the HUD apparatus becomes higher, luminous efficiency is significantly reduced. Therefore, this measure is particularly the urgent need for an HUD apparatus aiming for a miniaturized configuration.

It is thus an object of the present invention to provide a head up display apparatus by which further miniaturization of the apparatus is realized without damaging or deteriorating an LED light source against intrusion of solar light.

The foregoing and other objects, and new features of the present invention will become more apparent from description of the present specification and the appending drawings.

### Means for Solving the Problem

An outline of representative invention of the present invention disclosed in the present application and the like will briefly be explained as follows.

A head up display apparatus according to a representative embodiment of the present invention is a head up display apparatus configured to display a virtual image corresponding to video to a driver by projecting the video onto a windshield of a vehicle, the head up display apparatus including: a video display apparatus including an LED light source and a display element, the video display apparatus being configured to form the video on the display element; and a virtual image optical system configured to cause light emitted from the video display apparatus to be reflected by the windshield to display the virtual image in front of the vehicle, wherein the virtual image optical system includes a concave mirror and an optical element, and wherein a freeform surface of the concave mirror is set so that an optical axis of video light traveling from the concave mirror toward the windshield is inclined in a horizontal direction.

Alternatively, there is provided a head up display apparatus configured to display a virtual image corresponding to video to a driver by projecting the video onto a windshield of a vehicle, the head up display apparatus including: a video display apparatus including an LED light source and a display element, the video display apparatus being configured to form the video on the display element; and a virtual image optical system configured to cause light emitted from the video display apparatus to be reflected by the windshield to display the virtual image in front of the vehicle, wherein the virtual image optical system includes a concave mirror and an optical element, wherein the head up display apparatus further comprises: a housing in an inside of which the video display apparatus and the concave mirror are stored, wherein an opening is formed on a part of the housing, a dimension and a shape of the opening allowing the video light whose optical axis is inclined in the horizontal direction to pass through the opening toward the windshield; and a reflecting plate provided at a part of an optical path, the reflecting plate being configured to block or transmit solar light intruding in the housing, the optical path reaching the display element from the opening of the housing via the concave mirror.

### Effects of the Invention

Effects obtained by representative invention of the present invention disclosed in the present application and the like will briefly be explained as follows. Namely, it becomes possible to realize further miniaturization of a head up display apparatus, and to prevent a LED light source from being damaged or deteriorated against intrusion of solar light.

### BRIEF DESCRIPTIONS OF THE DRAWINGS

FIG. 1 is a view illustrating an outline of an example of an operation concept of a head up display apparatus according to one embodiment of the present invention;

FIG. 2 is a view illustrating an outline of an example of an implementation of the head up display apparatus according to one embodiment of the present invention;

FIG. 3 is a view for explaining a configuration of the head up display apparatus and rays according to one embodiment of the present invention;

FIG. 4 is a view for explaining a configuration of the head up display apparatus and rays according to another embodiment of the present invention;

FIG. 5 is a view illustrating a detailed example of an implementation of a video display apparatus according to one embodiment of the present invention; and

FIG. 6 is a view illustrating one example of means for blocking and reflecting solar light in the head up display apparatus according to another embodiment of the present invention.

### DETAILED DESCRIPTION OF PREFERRED EMBODIMENTS

Hereinafter, one embodiment of the present invention will be described in detail with reference to the drawings. Note that the same reference numeral is assigned to the same element (or component) in all of Figures for explaining the embodiments and repeated explanation thereof is omitted. On the other hand, a component has been explained in a certain drawing while applying a reference numeral thereto is not illustrated again when another drawing is to be explained, but the element may be referred to by applying the same reference numeral thereto. Further, in each of the embodiments described below, a case where a head up display (HUD) apparatus is installed in a vehicle such as an automobile will be described as an example. However, the HUD apparatus can also be applied to other vehicle such as an electric train or an airplane. Further, the HUD apparatus can also be applied to an HUD apparatus used in one other than the vehicle.

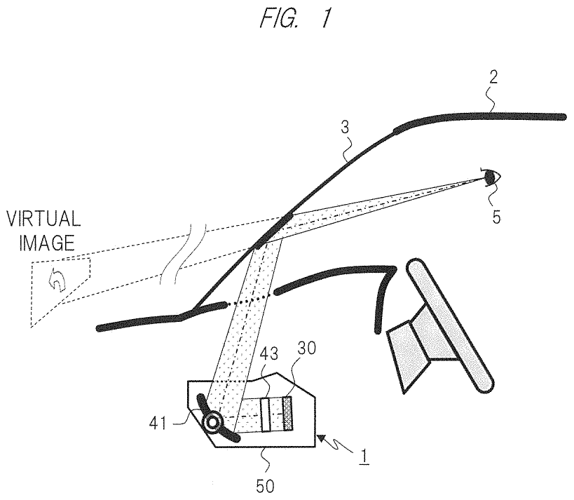

FIG. 1 is a view illustrating an outline of an example of an operation concept of a head up display apparatus according to a first embodiment of the present invention. In an HUD apparatus 1 according to the present embodiment, a video display apparatus 30 is arranged in a housing 50 (or at a portion at which it is detachable to the housing 50 as will be described later). Video displayed by the video display apparatus 30 is reflected by a concave mirror 41 to project the reflected video onto a windshield 3 of a vehicle 2.

Here, a projected member is not limited to the windshield 3. The projected member can be the other member such as a combiner so long as it is a member to which video is projected. Further, the video display apparatus 30 is configured by a projector or an LCD (Liquid Crystal Display) provided with a backlight, for example. The video display apparatus 30 may be a light-emitting VFD (Vacuum Fluorescent Display) or the like. The video display apparatus 30 may be one that displays video on a screen by a projection apparatus. Such a screen may be configured by a microlens array in which microlenses are arranged two-dimensionally, for example.

The concave mirror 41 is configured by a freeform surface mirror, a mirror having an asymmetrical shape with respect to an optical axis or the like, for example. More specifically, in order to reduce distortion of a virtual image, a shape of the concave mirror 41 makes a radius of curvature relatively smaller so that a magnification factor becomes larger in an area of an upper portion (that is, since a ray reflected herein is reflected by a lower portion of the windshield 3, a distance with a field of view of a driver 5 becomes relatively shorter), for example. On the other hand, the radius of curvature is made relatively larger so that the magnification factor becomes smaller in an area of a lower portion of the concave mirror 41 (that is, since a ray reflected herein is reflected by an upper portion of the windshield 3, the distance with the field of view of the driver 5 becomes relatively longer). By arranging the video display apparatus 30 so as to be inclined with respect to the optical axis of the concave mirror 41, it becomes possible to correct a difference of image magnification as described above, and this makes it possible to obtain excellent focus performance in the whole video display area.

The driver 5 views the video projected onto the windshield 3, thereby viewing and recognizing the above video as a virtual image through and in front of the transparent windshield 3. By adjusting an angle of the concave mirror 41 to adjust a position at which the video is projected onto the windshield 3, the head up display apparatus may be configured so that a display position of the virtual image viewed by the driver 5 can be adjusted in a vertical direction. Note that the content to be displayed as the virtual image is not limited particularly. For example, it is possible to appropriately display vehicle information, navigation information, video of a landscape in front of the vehicle photographed by a camera (not illustrated in the drawings) (a monitoring camera, an around viewer or the like), and the like.

In order to make a size of the virtual image recognized by the driver 5 of the video display apparatus 30 larger to a practical dimension, an effective screen size of the video display apparatus 30 used as an HUD is required to make a distance from the concave mirror 41 to the virtual image larger if a screen dimension of the video display apparatus 30 is determined. As a result, a dimension of the HUD apparatus 1 had to become larger. Further, the windshield 3 on which video is projected is normally arranged so as to be inclined longitudinally when viewed from the driver 5. Therefore, it was difficult to match image magnification between an upper portion and a lower portion of the virtual image.

In contrast, in the conventional technique as described in Patent document 1 mentioned above, an optical path folding mirror is provided between the driver 5 and a display device (the video display apparatus 30 in the present embodiment) in addition to the concave mirror 41. This causes an optical path itself to becomes longer so that an optical path difference is made smaller in an area in which image magnification is partially different. This makes it possible to reduce a partial change of the image magnification (distortion of the image) and a volume of the apparatus while securing a distance from the concave mirror 41 to the virtual image.

However, since two mirrors including the concave mirror 41 and the optical path folding mirror are required, a degree of freedom of arrangement of the mirrors is restricted. There is necessary to arrange the two mirrors so as to be separated from each other to an extent. Therefore, this becomes an obstacle for miniaturization of the apparatus. Further, necessity and concrete means of correction of aberration generated in the virtual image viewed and recognized by the driver 5 is not described at all and not considered in Patent document 1.

In contrast, in the HUD apparatus 1 according to the present embodiment, in order to realize further miniaturization of the apparatus, as illustrated in FIG. 1, a mirror to form a virtual image is configured by one concave mirror 41. Moreover, a lens 43 for correcting distortion and the like (hereinafter, referred to as a “distortion correcting lens 43”) is arranged between the driver 5 and the video display apparatus 30 as a transmission type optical element. At least one surface of the lens 43 is a concave surface (thus, having negative refractive power), for example. Herewith, even in a case where a distance between the concave mirror 41 and the video display apparatus 30 is shortened, the video light is controlled so as to be incident at a desired position of the concave mirror 41 by controlling an emission direction of a line of the video light from the video display apparatus 30. As a result, even though the HUD apparatus 1 is miniaturized, it is possible to significantly reduce distortion y means of the shape of the concave mirror 41.

According to the configuration of the present embodiment described above, it is possible to reduce distortion and aberration of the virtual image viewed and recognized by the driver 5 to a level of no practical problem, and improve visibility while suppressing an increase in size and complication of the HUD apparatus 1. Namely, by controlling the emission direction of the ray toward the concave mirror 41 by means of the distortion correcting lens 43, distortion aberration is corrected in accordance with the shape of the concave mirror 41. Moreover, a surface shape of the transmission type optical element is set to a freeform surface, thereby also correcting focus performance of the virtual image.

Further, in order to heighten an aberration correcting capability, a plurality of distortion correcting lenses 43 may be provided. Alternatively, in place of distortion correction by the distortion correcting lens 43, by arranging a concave mirror to control an incident position of the ray toward the concave mirror 41 in addition to folding of the optical path, distortion aberration may be reduced. It goes without saying that it does not depart from a technical idea or a scope of the present invention even though the optical element optimally designed in order to further improve aberration correcting capability is provided between the concave mirror 41 and the video display apparatus 30 in this manner.

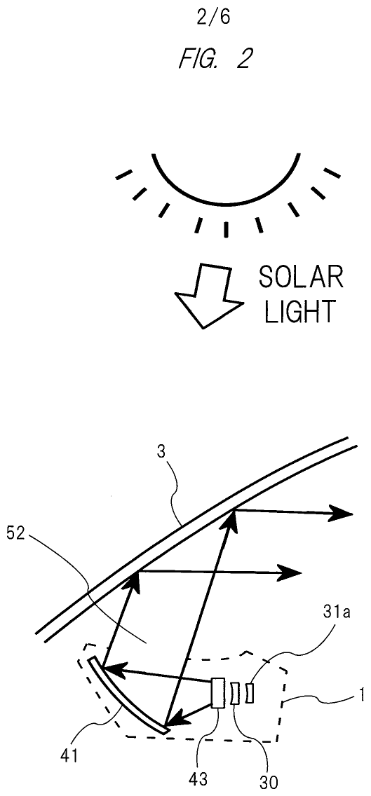

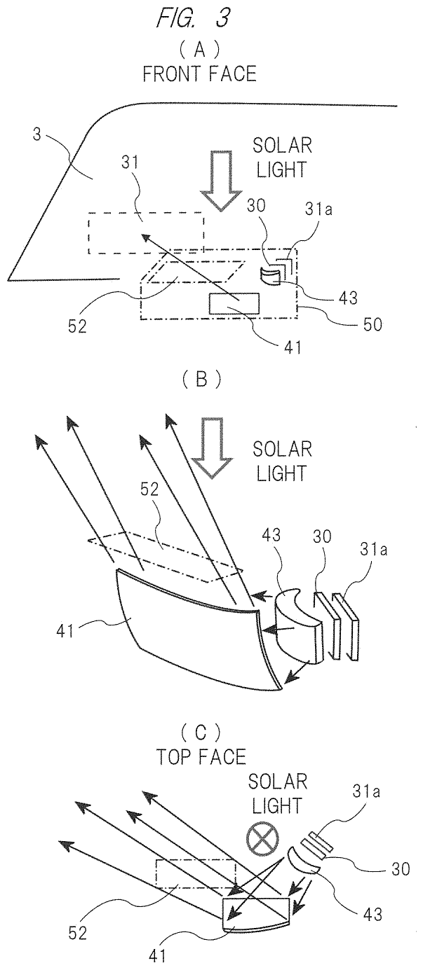

Moreover, in the HUD apparatus 1 according to the present embodiment, the freeform surface of the concave mirror 41 is designed so that the optical axis of video light traveling from the concave mirror 41 toward the windshield 3 is inclined (or offset) in a horizontal direction. This causes solar light to intrude therein and reach a liquid crystal panel that is the video display apparatus 30 of the HUD apparatus 1, for example. In a case of the worst, a polarizing plate or the like at an emission side is prevented from damaged or deteriorated by concentrated solar light. FIG. 2 and FIG. 3 illustrate an installation position of the HUD apparatus 1 with respect to the windshield 3 and the optical path of the video light projected from the concave mirror 41 with the freeform surface by means of arrows.

FIG. 2 illustrates, by arrows, a state where light from an LED light source 31a as video light passes through the distortion correcting lens 43 via the video display apparatus 30 configured by the LCD in the HUD apparatus 1, for example, and travels toward the windshield 3 by the concave mirror 41. Note that at this time, the video light passes through an opening or light transmissive member (referred to also as an “antidazzle plate”) 52 to travel toward the windshield 3. The opening 52 is formed on an upper surface of the housing 50 so as to be inclined (or offset) in the horizontal direction. This opening 52 has a dimension and a shape in which only the video light whose optical axis is inclined (or offset) in the horizontal direction by the concave mirror 41 can travel toward the windshield 3.

FIG. 3 respectively shows a front view (FIG. 3(A)) when the HUD apparatus 1 is viewed from a front surface of a vehicle, a perspective view (FIG. 3(B)), and a top view (FIG. 3(C)) when viewed from the top thereof. As is apparent from these drawings, video light from the LED light source 31a, the video display apparatus 30, and the distortion correcting lens 43 (hereinafter, collectively referred to also as a “video light source apparatus”) is reflected by the concave mirror 41 so as to be inclined (or offset) in a horizontal direction. Then, after this reflected video light passes through the opening 52 of the housing 50, the video light is projected to a predetermined area 31 of the windshield 3 (illustrated by a broken line in FIG. 3). In other words, the opening 52 of the housing 50 is arranged at a position offset from the concave mirror 41 in the horizontal direction.

On the other hand, in a case where the vehicle travels in the daytime, as illustrated in FIG. 2, the windshield 3 is exposed to solar light. As has already been mentioned, the solar light may be incident at an angle close to the video light reflected by the concave mirror 41 depending upon a state of the vehicle. At that time, in particular, during a stopping state of the vehicle (during parking or the like), for example, in a case where strong solar light such as midsummer is incident at the angle, part of the solar light passes through the opening 52 described above to intrude in the HUD apparatus 1. This intruding solar light reversely travels on the optical path of the video light via the concave mirror 41 to reach the liquid crystal panel that is the video display apparatus of the HUD apparatus 1. In a case of the worst, the polarizing plate or the like at the emission side is to be damaged or deteriorated by the concentrated solar light. Moreover, temperature rise in the HUD housing that occurring due to intrusion of the solar light becomes more remarkable when the HUD apparatus is miniaturized.

In order to reduce the intrusion of the solar light described above, as is apparent from FIGS. 3(A) to 3(C) described above, in particular, the top view (FIG. 3(C)) when viewed from the top of the vehicle, the opening 52 described above may be arranged at a position offset from the concave mirror 41. By arranging the opening 52 in this manner, when to look in the housing 50 from the opening 52 thereof, it is impossible or hardly to peep in the whole concave mirror 41 from the opening 52. However, in some cases, it becomes an extent that a part thereof can be peeped. Namely, as illustrated in FIG. 2, the solar light described above beats down from above of the vehicle. For that reason, even though solar light passes through the opening 52 described above to intrude in the HUD apparatus 1, the solar light does not reach the concave mirror 41. Therefore, it is possible to prevent the solar light to reversely travel on the optical path for the video light via the concave mirror 41. Note that, even though the solar light reaches the concave mirror 41, it is merely a part of the mirror, whereby it is thought that an influence of heat generation due to that is small. Namely, even in a case where the vehicle is exposed under strong solar light such as midsummer during parking, it is possible to prevent a situation that the solar light damages or deteriorates the LED light source 31a that is an optical component of the HUD apparatus.

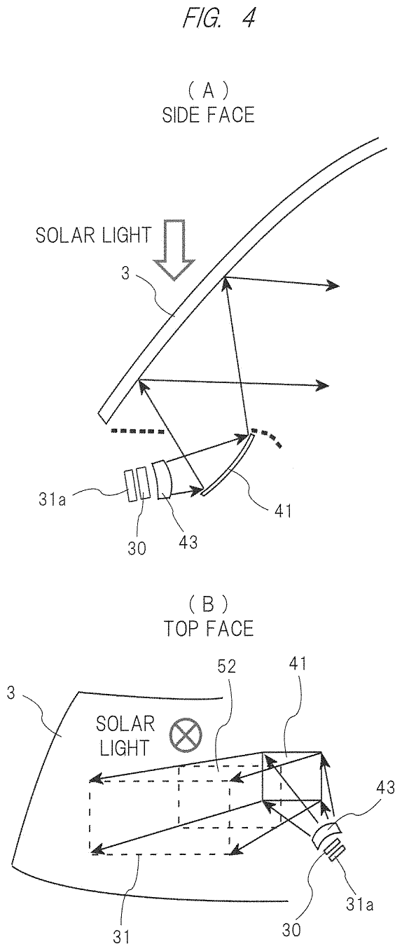

Further, in the HUD apparatus 1, as the other configuration suitable for miniaturization, it can be thought a case where a configuration in which the video light source apparatus is arranged behind the concave mirror 41, for example, as illustrated in FIG. 4(A), is adopted depending upon arrangement and configurations of respective members in place of the configuration illustrated in FIG. 1 and FIG. 2 described above (that is, the video light source apparatus including the LED light source 31a, the video display apparatus 30, and the distortion correcting lens 43 is arranged behind the concave mirror 41 in a traveling direction of the vehicle). In such a case, as illustrated in FIG. 4(B), by designing the freeform surface of the concave mirror 41 so that the optical axis of the video light traveling from the concave mirror 41 toward the windshield 3 is inclined in the horizontal direction with respect to the windshield 3, it is possible to prevent or reduce the solar light from passing through the opening 52 of the housing 50 to intrude in the HUD apparatus 1, and reversely traveling on the optical path of the video light to reach the LED light source 31a similarly to the above. Namely, even in a case where the vehicle is exposed to strong solar light such as midsummer during parking, it is possible to prevent a situation where the solar light reaches the liquid crystal panel that is the video display apparatus of the HUD apparatus and the concentrated solar light damages or deteriorates the polarizing plate or the like at the emission side.

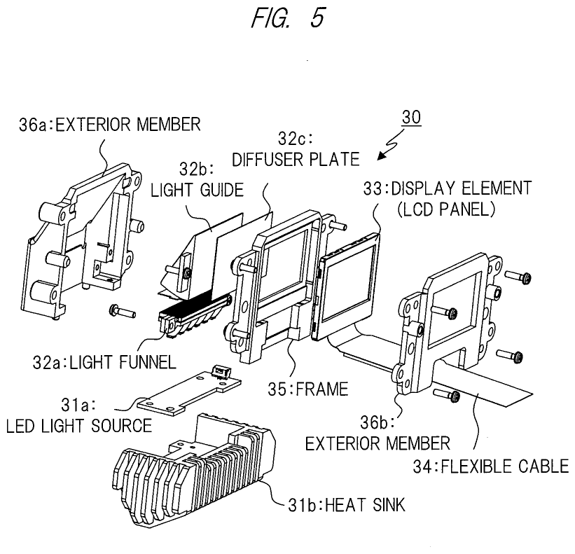

Subsequently, FIG. 5 shows an outline of an implementation of the video display apparatus 30. Here, a state where the video display apparatus 30 thus modularized is taken into respective components is illustrated by a perspective view. A display element 33 such as a LCD panel modulates light from the backlight on the basis of a video signal inputted from a main board via a flexible cable 34, whereby the video display apparatus 30 displays video. Polarizing plates (not illustrated in the drawings) are respectively arranged at a backlight side of the LCD panel (light incident surface) and a concave mirror side (light emission side). The video displayed by the video display apparatus 30 is outputted to a virtual image optical system (in the present embodiment, the distortion correcting lens 43 and the concave mirror 41 illustrated in FIG. 2) through the opening, and a virtual image that the driver can view and recognize is generated.

As a light source element in the backlight, an LED (Light Emitting Diode) light source 31a is used, for example, as a solid light source. The LED light source 31a is relatively low cost and has high reliability. The LED light source 31a is a plane emission type for high output. In the example illustrated in FIG. 5, the LED light source 31a is implemented as an LED board. In this case, for example, usage efficiency of diverging light is improved by using a technical devise as will be described later.

Luminous efficiency with respect to electric power inputted to the LED differs depending upon luminescent color, and is about 20 to 30%. The remaining is almost converted into heat. For this reason, a fin for radiating heat (that is, a heat sink 31b) composed of a member with high thermal conductivity (for example, a metallic member made of aluminum or the like) is provided in a frame 35 to which the LED light source 31a is attached, thereby radiating heat to the outside. This makes it possible to obtain an effect that the luminous efficiency itself of the LED light source 31a is improved. In particular, luminous efficiency of an LED whose luminescent color is red, which goes on the market currently, decreases significantly when junction temperature becomes higher. Chromaticity of video changes at the same time. Therefore, in order to prioritize temperature reduction of the LED light source 31a, it is desirable that an area of the radiating fin in the heat sink 31b is made larger to enhance cooling efficiency.

In order to efficiently introduce diverging light from the LED light source 31a to the display element 33, a light guide 32b is used in the example illustrated in FIG. 5. In this case, in order to prevent dust or the like from adhering, it is desirable that the video display apparatus 30 is modularized by covering the whole of the light guide 32b, the display element 33 and the like by exterior members 36a, 36b, for example.

Further, in the example of FIG. 5, in order to make parallel light by taking in the diverging light from the LED light source 31a, a plurality of light funnels 32a composed of collimate lenses or the like is provided. In each of the light funnels 32a, an opening for taking in the diverging light from the LED light source 31a is optically connected by inserting a medium between each of the light funnels 32a and the LED light source 31a on a plane, for example, or is caused to have a concentrating action as a convex shape. This causes an incident angle of light incident in a boundary surface of the light funnel 32a to be made smaller by converting the diverging light into parallel light as much as possible. As a result, it is possible to make a divergence angle further smaller after passing through the light funnel 32a. Therefore, control of the light of the light source, which travels toward the display element 33 after being reflected by the light guide 32b, becomes easier.

Moreover, in order to improve the usage efficiency of the diverging light from the LED light source 31a, polarization conversion is carried out on a junction between the light funnel 32a and the light guide 32b by using a PBS (Polarizing Beam Splitter), thereby converting into a desired polarizing direction. This makes it possible to improve efficiency of the incident light into the display element 33. In a case where polarizing direction of the light from the light source is aligned in this manner, it is further desirable that material with small double refraction is used as raw material of the light guide 32b. This makes it possible to suppress a problem such as coloring at the time of black display from occurring, for example, in a case where a direction of a polarized wave is rotated and the wave passes through the display element 33.

Light flux, whose divergence angle is reduced in this manner, from the LED light source 31a is controlled by the light guide 32b, and is reflected on a total reflection surface provided on a slope of the light guide 32b (in the example illustrated in FIG. 5, a surface at a side of the exterior member 36a). After the light flux is diffused by a diffuser plate 32c (diffuser), which is arranged between a surface (emission surface) of the light guide 32b opposed to the total reflection surface and the display element 33, the light flux enters the display element 33 (LCD panel). In the example illustrated in FIG. 5, by arranging the diffuser plate 32c between the light guide 32b and the display element 33, the light flux from the LED light source 31a is diffused. However, the video display apparatus 30 is not limited to such a configuration. Even by providing a minute uneven shape on the emission surface of the light guide 32b to have a diffusion effect, for example, in place of arrangement of the diffuser plate 32c, it is also possible to obtain the similar effect.

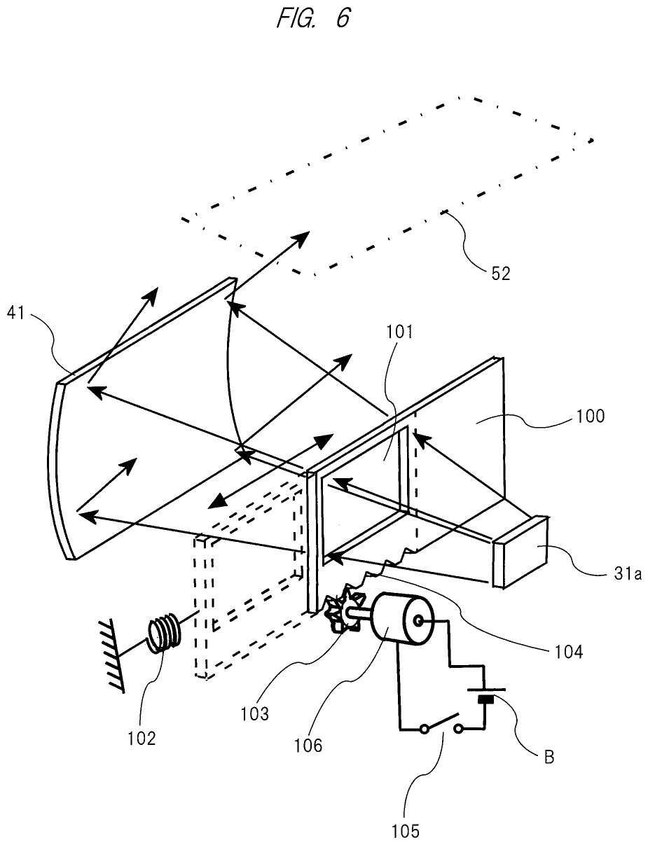

Moreover, in the HUD apparatus 1 according to the present embodiment, it is preferable that means for blocking and reflecting the solar light, which intrudes in the housing 50, is provided in addition to the configuration described above. Note that such means is means for blocking or reflecting the solar light (hereinafter, referred to as a “reflecting plate”), which intrudes in the housing 50, at least in the middle of the optical path of the video light, which reaches the opening 52 of the housing 50 from the video display apparatus 30 via the concave mirror 41, as illustrated in FIG. 6. As is apparent from FIG. 6, in this reflecting plate 100, an opening 101 that allows the rays from the video display apparatus 30 to transmit is formed on a half of a surface thereof, and a light reflecting plate or blocking plate is formed on the remaining half. The reflecting plate 100 is held at a predetermined position by attaching an elastic body such as a spring 102 to a part of the reflecting plate 100, for example. In addition, this reflecting plate 100 has a structure in which the optical path can be opened or closed by moving the position thereof by means of driving means such as an electric motor 106, for example. Note that a reference numeral 103 of FIG. 6 denotes a gear attached to the axis of rotation of the electric motor 106 described above; a reference numeral 104 denotes a gear that is formed at a lower side of the reflecting plate 100 and is to engage with a gear 103; a reference numeral 105 denotes a switch that interlocks with an ignition key or the like; and a reference numeral B denotes a battery of the vehicle.

According to the configuration described above, for example, a switch 105 is turned off (or opened) in a state where the vehicle is stopped in a parking area and the ignition key is turned off. Thus, driving force from the electric motor 106 is not generated, and the reflecting plate 100 is placed at a position illustrated by a broken line of FIG. 6 (that is, a position biased by an elastic body such as the spring 102). Namely, it becomes a state where the optical path reaching the opening 52 of the housing 50 from the video display apparatus 30 via the concave mirror 41 is blocked. On the other hand, in a state where the ignition key is turned on, the switch 105 is turned on (or closed). The driving force generated by the electric motor 106 causes the reflecting plate 100 to move to a position illustrated by a solid line of FIG. 6 against bias force of the spring 102 or the like. Namely, it becomes a state where the optical path reaching the opening 52 of the housing 50 from the video display apparatus 30 via the concave mirror 41 is opened or released.

By providing the reflecting plate 100 described above in the housing 50 in this manner, the optical path on which the intruding light may reversely travel is blocked at the time of stopping of the vehicle at which intruding solar light may become a problem. Therefore, it is possible to more surely prevent a situation where the solar light reaches the liquid crystal panel that is the video display apparatus of the HUD apparatus even under strong solar light such as midsummer and the concentrated solar light damages or deteriorates the polarizing plate or the like at the emission side.

Note that in the above embodiment, the reflecting plate 100 for preventing solar light from being incident in the video display apparatus 30 has been explained as a member whose position can be moved automatically in accordance with the ignition key. However, the video display apparatus 30 according to the present embodiment is not limited to this. For example, by using a liquid crystal plate of the like that changes between a transparent state and an opaque state by means of application of voltage, it is possible to achieve the similar effect without using moving means. Further, by providing the reflecting plate 100 described above in the opening 52 of the housing 50, for example, it is possible to switch between a transparent state and an opaque (or reflectable) state without using the moving means. Alternatively, the switch 105 can be interlocked with an operation of a member other than the ignition key to activate the reflecting plate 100. By adopting means for preventing the solar light from entering by means of the reflecting plate 100 described above together with inclination (or offset) in the horizontal direction of the optical axis of the video light traveling from a reflecting mirror toward the windshield, which has already been described, it is possible to expect more reliable effect. However, the present invention is not limited to it. For example, it is possible to adopt one of them independently.

As have been described above in detail, according to the HUD apparatus 1 of the present embodiment, the mirror to form a virtual image, which is suitable for realizing further miniaturization of the apparatus can be configured by only one concave mirror 41. In addition, it is possible to prevent solar light, which becomes a problem by adopting the configuration, from reaching the liquid crystal panel that is the video display apparatus and prevent the concentrated solar light from damaging or deteriorating the polarizing plate or the like at the emission side. Namely, it is possible to provide a head up display apparatus with excellent practical use, by which further miniaturization of the apparatus is realized and the LED light source is not damaged or deteriorated against intrusion of solar light. Further, it is possible to prevent solar light from reaching the liquid crystal panel and prevent the solar light reflected by the liquid crystal panel from returning a field of view (FOV) of the driver.

As described above, the invention made by inventors of the present application has been described specifically on the basis of the embodiments. However, the present invention is not limited to the embodiments described above, and it goes without saying that the present invention may be modified into various forms without departing from the substance thereof. For example, the embodiments described above have been explained in detail for explaining the present invention clearly. The present invention is not necessarily limited to one that includes all configurations that have been explained. Further, a part of the configuration of one embodiment can be replaced by a configuration of the other embodiment. Further, a configuration of the other embodiment can be added to a configuration of one embodiment. Moreover, a part of the configuration of each of the embodiments can be added to the other configuration, deleted or replaced thereby.

### REFERENCE SINGS LIST

1 . . . HUD apparatus, 2 . . . vehicle, 3 . . . windshield, 30 . . . video display apparatus, 41 . . . concave mirror, 43 . . . distortion correcting lens, 50 . . . housing, 52 . . . opening, 100 . . . reflecting plate, 101 . . . opening, 106 . . . electric motor, 105 . . . switch.

1. A head up display apparatus configured to display a virtual image corresponding to video to a driver by projecting the video onto a windshield of a vehicle, the head up display apparatus comprising:
a video display apparatus including an LED light source and a display element, the video display apparatus being configured to form the video on the display element; and
a virtual image optical system configured to cause light emitted from the video display apparatus to be reflected by the windshield to display the virtual image in front of the vehicle,
wherein the virtual image optical system includes a concave mirror and an optical element, and
wherein a freeform surface of the concave mirror is set so that an optical axis of video light traveling from the concave mirror toward the windshield is inclined in a horizontal direction.

2. The head up display apparatus according to claim 1, further comprising:
a housing in an inside of which the video display apparatus and the concave mirror are stored,
wherein an opening is formed on a part of the housing, a dimension and a shape of the opening allowing the video light whose optical axis is inclined in the horizontal direction to pass through the opening toward the windshield.

3. The head up display apparatus according to claim 2,
wherein the opening is arranged at a position different from that of the concave mirror in the horizontal direction.

4. The head up display apparatus according to claim 2, further comprising:
a reflecting plate provided at a part of an optical path, the reflecting plate being configured to block or transmit solar light intruding in the housing, the optical path reaching the display element from the opening of the housing via the concave mirror.

5. A head up display apparatus configured to display a virtual image corresponding to video to a driver by projecting the video onto a windshield of a vehicle, the head up display apparatus comprising:
a video display apparatus including an LED light source and a display element, the video display apparatus being configured to form the video on the display element; and
a virtual image optical system configured to cause light emitted from the video display apparatus to be reflected by the windshield to display the virtual image in front of the vehicle,
wherein the virtual image optical system includes a concave mirror and an optical element,
wherein the head up display apparatus further comprises:
a housing in an inside of which the video display apparatus and the concave mirror are stored, wherein an opening is formed on a part of the housing, a dimension and a shape of the opening allowing the video light whose optical axis is inclined in the horizontal direction to pass through the opening toward the windshield; and
a reflecting plate provided at a part of an optical path, the reflecting plate being configured to block or transmit solar light intruding in the housing, the optical path reaching the display element from the opening of the housing via the concave mirror.

6. The head up display apparatus according to claim 5,
wherein the reflecting plate is provided at the opening of the housing.

7. The head up display apparatus according to claim 5,
wherein the reflecting plate is provided on a part of the optical path reaching the light source from the concave mirror.

8. The head up display apparatus according to claim 7,
wherein the reflecting plate allows the optical path to be opened or closed automatically.
